(19) United States
(12) Patent Application Publication
(10) Pub. No.: US 2015/0015219 A1
(43) Pub. Date: Jan. 15, 2015

(54) DC/DC CONVERTER

(71) Applicant: ROHM CO., LTD, Kyoto (JP)

(72) Inventors: Tsutomu ISHINO, Kyoto (JP); Tadayuki SAKAMOTO, Kyoto (JP)

(73) Assignee: ROHM CO., LTD, Kyoto (JP)

(21) Appl. No.: 14/253,116

(22) Filed: Apr. 15, 2014

(30) Foreign Application Priority Data
Apr. 15, 2013 (JP) 2013-085172
Mar. 31, 2014 (JP) 2014-073108

(51) Int. Cl. H02M 3/158

(52) U.S. Cl. CPC H02M 3/1584
USPC 323/271

(57) ABSTRACT

A DC/DC converter comprises: inductors L provided for respective channels; switching circuits provided for the respective channels; and a controller configured to change the number of channels to be activated, i.e., K, according to an amount of a load current I_{OUT} that flows through a load, and to control the switching circuits that correspond to the activated channels such that a feedback voltage V_{FB} that corresponds to an output voltage V_{OUT} matches a predetermined target voltage V_{REF}. The controller activates only a single channel in a lightest load state. The inductance L of the inductor L provided for the aforementioned single channel is set to a value that differs from the inductances of the inductors L of the other channels so as to provide high efficiency in the lightest load state.

The present invention claims priority under 35 U.S.C. §119 to Japanese Application No. 2013-085172 filed Apr. 15, 2013, and Japanese Application No. 2014-073108 filed Mar. 31, 2014, the entire contents of which are incorporated herein by reference.

### BACKGROUND OF THE INVENTION

1. Field of the Invention

The present invention relates to a DC/DC converter.

2. Description of the Related Art

Accompanying advances in the semiconductor technology, reduction in the operating voltage of semiconductor devices is being earnestly pursued. There are known semiconductor devices developed such that they require a power supply voltage of only 1.5 V to operate, examples of which include CPUs (Central Processing Units), GPUs (Graphical Processing Units), and DSPs (Digital Signal Processors). If a power supply voltage on the order of 3 V is directly supplied to such a semiconductor device, for example, this leads to an increase in power loss, which is a problem. In this case, a DC/DC converter is employed in order to step down the power supply voltage of 3 V to 1.5 V.

Here, with a semiconductor device such as a CPU, a GPU, or a DSP, in the standby state, the operating current drops to a level of substantially zero. In the operating state, the operating current increases according to an increase in the signal processing amount. That is to say, the output current (load current) of the DC/DC converter dynamically fluctuates in a range between several mA and several A.

In order to support such a large dynamic range of the load current, a multi-phase DC/DC converter is employed (Japanese Patent Application Laid Open No. 2006-211760).

The multi-phase DC/DC converter has multiple channels, and includes multiple inductors provided for the respective channels. With conventional techniques, the inductors provided for the respective channels are designed to have equal inductance. Specifically, the inductors are designed to have equal inductance so as to provide high efficiency in a heavy load state in which a large load current flows.

In recent years, there is a great demand for such a DC/DC converter having further reduced power consumption from the viewpoint of power saving. In particular, there is a great demand for such a DC/DC converter having power consumption that is as small as possible in a light load state in which loads such as a CPU and the like enter the standby state, in order to provide reduced power consumption in the overall system.

### SUMMARY OF THE INVENTION

The present invention has been made in order to solve such a problem. Accordingly, it is an exemplary purpose of an embodiment of the present invention to provide a multi-phase DC/DC converter having improved efficiency in a light load state.

An embodiment of the present invention relates to a multi-phase DC/DC converter. The DC/DC converter comprises: an output line connected to a load; an output capacitor connected to the output line; multiple inductors provided for respective channels, and arranged such that one end of each of the inductors is connected to the output line; multiple switching circuits provided for the respective channels, and arranged such that their respective output terminals are connected to the other ends of the respective inductors; and a controller configured to change the number of channels to be activated according to an amount of load current that flows through the load, and to control the switching circuits that correspond to the activated channels such that a feedback voltage that corresponds to an output voltage at the output line matches a predetermined target voltage.

In a lightest load state in which only a single channel is activated, the inductor provided for the single channel is designed to have an inductance value that differs from the inductances of the inductors of the other channels so as to provide high efficiency in the lightest load state.

With such an embodiment, the inductance of the inductor of the channel which is to be activated in the lightest load state, in which the load current is at its minimum, is determined giving priority to the efficiency in the lightest load state, instead of the efficiency in the heavy load state. Thus, such an arrangement provides improved efficiency in the lightest load state.

Also, the inductors of the aforementioned other channels may be configured to have equal values.

Also, the inductances of the inductors of the aforementioned other channels may be determined so as to provide high efficiency in a heavy load state.

Also, the controller may comprise: an error amplifier configured to amplify the difference between the feedback voltage and the target voltage so as to generate an error voltage; and multiple pulse modulators provided for the respective channels, and each configured to generate a pulse signal having a duty ratio adjusted such that an average value of a coil current that flows through the inductor of the corresponding channel approaches a current value that corresponds to the error voltage.

This allows the currents that flow through the respective inductors of the multiple channels to have an equal value.

Also, the multiple pulse modulators may each comprise: a current detection circuit configured to detect the corresponding coil current, and to generate a detection signal that corresponds to the coil current; a filter configured to remove a high-frequency component of the detection signal; a slope compensator configured to superimpose a slope signal on the detection signal; a comparator configured to compare the output of the slope compensator with the error voltage, and to generate a reset signal; and a pulse generator configured to generate a pulse signal having a level that transits according to the reset signal and a clock signal having a predetermined period.

Another embodiment of the present invention also relates to a multi-phase DC/DC converter. The DC/DC converter comprises: an output line connected to a load; an output capacitor connected to the output line; multiple inductors provided for respective channels, and arranged such that one end of each of the inductors is connected to the output line; multiple switching circuits provided for the respective channels, and arranged such that their respective output terminals are connected to the other ends of the respective inductors; and a controller configured to change the number of channels to be activated according to an amount of load current that flows through the load, and to control the switching circuits that correspond to the activated channels such that a feedback voltage that corresponds to an output voltage at the output line matches a predetermined target voltage. In a lightest load state in which only a single channel is activated, the inductor provided for the single channel is designed to have an inductance value that is higher than the inductances of the inductors of the other channels.

Such an embodiment is capable of reducing the peak value of the coil current that flows in the light load state, and the reduction in the power loss due to the on resistances of the switching elements of the switching circuits exceeds the increase in the power loss accompanying the increase in the switching frequency. Thus, such an arrangement provides the overall system with improved efficiency.

Also, the inductors of the aforementioned other channels may be configured to have equal values.

Also, the inductances of the inductors of the aforementioned other channels may be determined so as to provide high efficiency in a heavy load state.

Also, the controller may comprise: an error amplifier configured to amplify the difference between the feedback voltage and the target voltage so as to generate an error voltage; and multiple pulse modulators provided for the respective channels, and each configured to generate a pulse signal having a duty ratio adjusted such that an average value of a coil current that flows through the inductor of the corresponding channel approaches a current value that corresponds to the error voltage.

This allows the currents that flow through the respective inductors of the multiple channels to have an equal value.

Also, the multiple pulse modulators may each comprise: a current detection circuit configured to detect the corresponding coil current, and to generate a detection signal that corresponds to the coil current; a filter configured to remove a high-frequency component of the detection signal; a slope compensator configured to superimpose a slope signal on the detection signal; a comparator configured to compare the output of the slope compensator with the error voltage, and to generate a reset signal; and a pulse generator configured to generate a pulse signal having a level that transits according to the reset signal and a clock signal having a predetermined period.

Yet another embodiment of the present invention relates to an electronic device. The electronic device may comprise: a processor; and any one of the DC/DC converters described above, configured to supply a power supply voltage to the processor.

It is to be noted that any arbitrary combination or rearrangement of the above-described structural components and so forth is effective as and encompassed by the present embodiments.

Moreover, this summary of the invention does not necessarily describe all necessary features so that the invention may also be a sub-combination of these described features.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a block diagram showing a configuration of an electronic device including a multi-phase DC/DC converter according to an embodiment;

FIG. 2 is an operation waveform diagram showing the operation of the DC/DC converter in the lightest load state;

FIG. 3 is a diagram showing the relation between the inductance of the inductor of the first channel and the efficiency of the DC/DC converter in the lightest load state;

FIGS. 4A and 4B show the efficiency in the heavy load state φ1 and the efficiency in the lightest load state φN, respectively;

FIG. 5 is a circuit diagram of a DC/DC converter according to a first modification; and

FIG. 6 is an operation waveform diagram showing the operation of the DC/DC converter shown in FIG. 5 in the heavy load state φN.

### DETAILED DESCRIPTION OF THE INVENTION

The invention will now be described based on preferred embodiments which do not intend to limit the scope of the present invention but exemplify the invention. All of the features and the combinations thereof described in the embodiment are not necessarily essential to the invention.

In the present specification, a state represented by the phrase “the member A is connected to the member B” includes a state in which the member A is indirectly connected to the member B via another member that does not affect the electric connection therebetween, in addition to a state in which the member A is physically and directly connected to the member B.

Similarly, a state represented by the phrase “the member C is provided between the member A and the member B” includes a state in which the member A is indirectly connected to the member C, or the member B is indirectly connected to the member C via another member that does not affect the electric connection therebetween, in addition to a state in which the member A is directly connected to the member C, or the member B is directly connected to the member C.

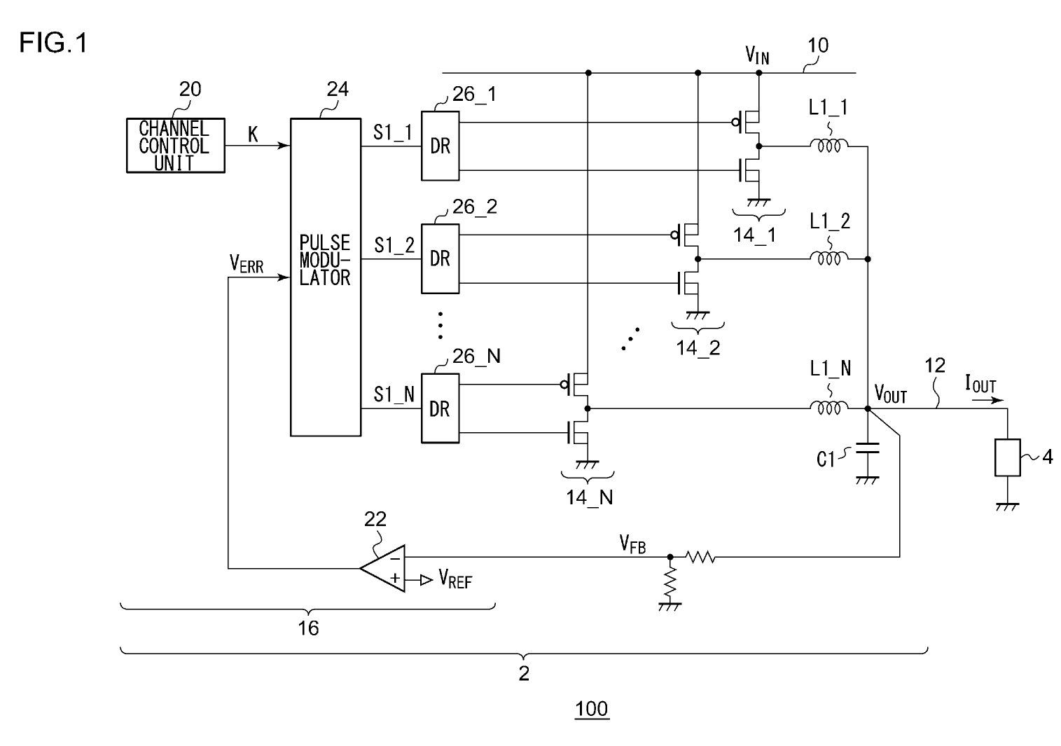

FIG. 1 is a block diagram showing a configuration of an electronic device 100 including a multi-phase DC/DC converter 2 having N channels (N represents an integer of 2 or more) according to an embodiment.

The electronic device 100 includes the DC/DC converter 2 and a load 4. Examples of such an electronic device 100 include laptop PCs, TVs, display apparatuses, recorder devices, and game devices. Examples of such a load 4 include CPUs, GPUs, and DSPs.

The DC/DC converter 2 includes an input line 10, an output line 12, multiple switching circuits 14_1 through 14_N, multiple inductors L1_1 through L1_N, and a controller 16.

The DC input voltage V_{IN} is supplied to the input line 10. The input voltage V_{IN} may be configured as a battery voltage from a battery, or otherwise a voltage obtained by rectifying and smoothing commercially-available AC voltage.

The output line 12 is connected to the load 4 having an operating current which dynamically fluctuates, examples of which include CPUs, DSPs, and the like. An output capacitor C1 is arranged between the output line 12 and the ground line.

The multiple (N) inductors L1_1 through L1_N are provided for the respective channels. One end of each inductor is connected to the output line 12.

The multiple switching circuits 14_1 through 14_N are provided for the respective channels. The output terminal LX of each switching circuit is connected to the other end of the corresponding one from among the inductors L1_1 through L1_N.

The controller 16 changes the number of channels to be activated, i.e., K (1≦K≦N), according to the value of the load current I_{OUT} that flows through the load 4. Subsequently, the controller 16 performs switching control for the switching circuits 14_1 through 14_K that correspond to the activated channels CH1 through CHK such that a feedback voltage V_{FB} that corresponds to the output voltage V_{OUT} at the output line 12 matches a predetermined target voltage V_{REF}. On the other hand, the controller 16 stops the switching of the deactivated channels CH(K+1) through CHN. The controller 16 may perform switching of the switching circuits 14_1 through 14_K of the activated channels CH1 through CHK with a phase difference of (360/N) degrees.

Specifically, in a heavy load state φN in which the load current I_{OUT} is large, K is set to N. In this state, all the channels CH1 through CHN are activated. In contrast, in the lightest load state φ1 in which the load current I_{OUT} is very small, or otherwise substantially zero, K is set to 1. Specifically, only the single channel CH1 is activated. When the load current I_{OUT} exhibits an intermediate value ranging between the heavy load state φN and the lightest load state φ1, the state may be set to an intermediate state from among states φ2 through φN−1 that correspond to K=2 through K=(N−1).

The controller 16 includes a channel control unit 20, an error amplifier 22, a pulse modulator 24, and multiple drivers 26_1 through 26_N.

The channel control unit 20 controls the number of channels to be activated, i.e., K, according to the load current I_{OUT}. The DC/DC converter 2 may include a current sensor which detects the load current I_{OUT}, for example. In this case, the channel control unit 20 may determine the number of channels to be activated, i.e., K, based on the detection value obtained by the current sensor.

The load 4 may have (i) a function of estimating the value of the load current I_{OUT} based on its own state. Also, the load 4 may include a built-in current sensor, and may have (ii) a function of measuring the value of the load current I_{OUT}. In this case, the channel control unit 20 may determine the number K of channels to be activated according to a control signal received from the load 4.

The error amplifier 22 amplifies the difference between the feedback voltage V_{FB} and the predetermined reference voltage V_{REF} so as to generate an error voltage V_{ERR}. The pulse modulator 24 generates pulse modulated pulse signals S1_1 through S1_K for the activated channels CH1 through CHK according to the error voltage V_{ERR} and the number K of channels to be activated. The error amplifier 22 adjusts the duty ratio of each of the pulse signals S1_1 through S1_K by means of pulse width modulation (PWM) or pulse frequency modulation (PFM). The pulse modulator 24 may be configured as a voltage mode pulse modulator or otherwise a current mode modulator, and the configuration of the pulse modulator 24 is not restricted in particular.

The multiple drivers 26_1 through 26_N are provided to the channels CH1 through CHN, respectively. The drivers 26_1 through 26_K of the activated channels CH1 through CHK perform switching of the corresponding switching circuits 14_1 through 14_K according to the respective pulse signals S1_1 through S1_K.

Next, description will be made regarding the decision method for the multiple inductors L1_1 through L1_N.

With the present embodiment, in the lightest load state φ1 in which the activated channel is the channel CH1 alone, the inductor L1 provided for the channel CH1 is designed to have an inductance value (which will be represented by L1_1) that differs from the inductance values (which will be represented by L1_2 through L1_N) of the other channels, so as to provide high efficiency in the lightest load state φ1.

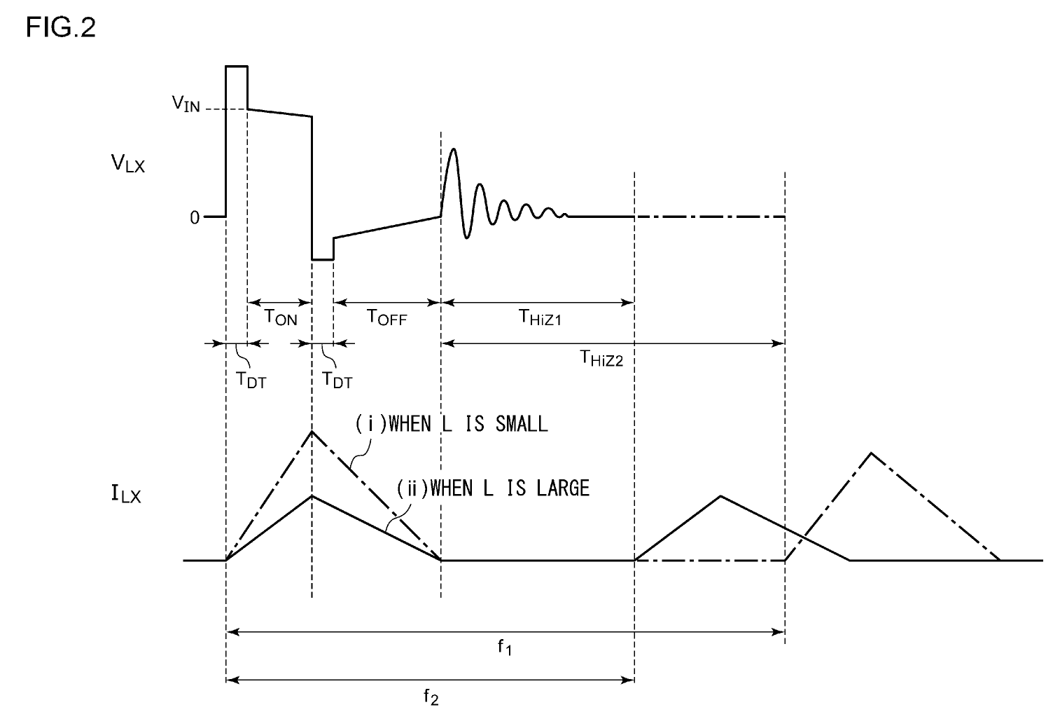

FIG. 2 is an operation waveform diagram showing the operation of the DC/DC converter 2 in the lightest load state. In the lightest load state, the controller 16 operates in a so-called PFM mode. In the PFM mode, the controller 16 repeats a cycle of an on period T_{ON}, an off period T_{OFF}, and a high-impedance period T_{HiZ}. FIG. 2 shows waveforms (i) and (ii) for the different inductance values of the inductor L1_1.

Specifically, during a given on period T_{ON}, a high-side transistor of the switching circuit 14_1 is turned on, which sets the output LX of the switching circuit 14_1 to the high level voltage V_{IN}. In this stage, the voltage (V_{IN}−V_{OUT}) is applied between both ends of the inductor L1_1. In this state, the current I_{LX} that flows through the inductor L1 rises with a slope which is proportional to (V_{IN}−V_{OUT})/L1_1, which increases the energy stored in the inductor L1_1.

For example, the pulse modulator 24 may fix the on period T_{ON} to a predetermined period of time.

Alternatively, the pulse modulator 24 may detect the coil current I_{LX} in the on period T_{ON}. In this case, the pulse modulator 24 may transit to the subsequent off period T_{OFF} when the coil current I_{LX} reaches a predetermined peak value.

During the subsequent off period T_{OFF}, the low-side transistor of the switching circuit 14_1 is turned on. In this state, the output LX of the switching circuit 14_1 is set to the low level voltage (ground voltage V_{GND}). During the off period T_{OFF}, the voltage V_{OUT} is applied between both ends of the inductor L1. In this state, the current that flows through the inductor L1_1 drops with a slope V_{OUT}/L1_1.

For example, the pulse modulator 24 may detect the coil current I_{LX} for the off period T_{OFF}, and may transit to the subsequent high-impedance period T_{Hiz} when the coil current I_{LX} thus detected becomes substantially zero.

During the on period T_{ON} and the off period T_{OFF}, the output capacitor C1 is charged by means of the current I_{LX} that flows through the inductor L1_1, thereby raising the output voltage V_{OUT}.

During the subsequent high-impedance period T_{Hiz}, both the high-side transistor and the low-side transistor of the switching circuit 14_1 are turned off. In this state, the switching terminal LX enters the high-impedance state. This suspends the current supply from the inductor L1 to the output capacitor C1. During the high-impedance period T_{Hiz}, the output capacitor C1 is discharged due to the load current I_{OUT}, which reduces the output voltage V_{OUT} with the passage of time.

For example, the pulse modulator 24 may compare the feedback voltage V_{FB} that corresponds to the output voltage V_{OUT} with the predetermined reference voltage V_{REF}. In this case, the pulse modulator 24 may transit to the on period T_{ON} when the feedback voltage V_{FB} drops to the reference voltage V_{REF}.

Before the on period T_{ON} and before the off period T_{OFF}, a dead time T_{DT} may be arranged in which both the high-side transistor and the low-side transistor of the switching circuit 14 are turned off. During the dead time T_{DT} before the on period T_{ON}, the current that flows through the inductor L1 flows via the body diode of the high-side transistor. Thus, in this state, the voltage V_{LX} at the switching terminal becomes V_{IN}+V_{F}. Here, V_{F} represents the forward voltage of the body diode. On the other hand, during the dead time T_{DT} before the off period T_{OFF}, the current that flows through the inductor L1 flows via the body diode of the low-side transistor. Thus, in this state, the voltage V_{LX} at the switching terminal becomes −V_{F}. Here, V_{F} represents the forward voltage of the body diode.

With the PFM control operation, a stable feedback control operation is performed such that the feedback voltage V_{FB} approaches the reference voltage V_{REF} as the bottom level.

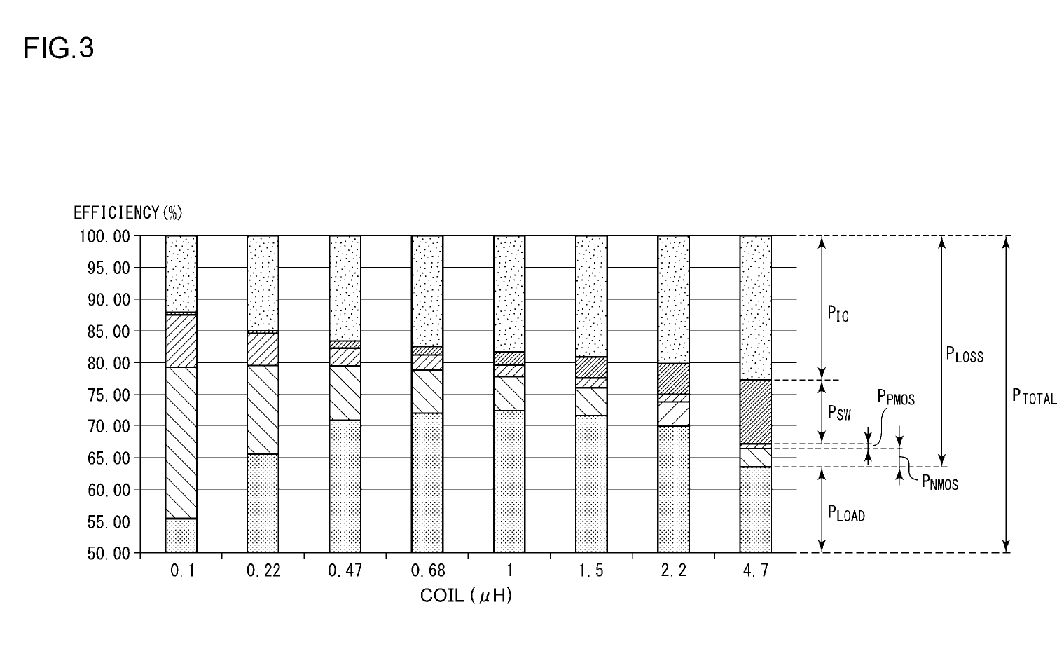

FIG. 3 is a diagram showing the relation between the inductance of the inductor L1_1 of the first channel CH1 and the efficiency of the DC/DC converter 2 in the lightest load state. The efficiency shown in FIG. 3 is calculated by simulation for when the DC/DC converter 2 is designed to have N=5 channels. It should be noted that the vertical axis is normalized such that total electric power P_{TOTAL} matches 100%.

The efficiency of the DC/DC converter 2 is represented by the ratio of the electric power P_{LOAD} supplied to the load 4 with respect to the total electric power P_{TOTAL} supplied to the DC/DC converter 2. The electric power P_{LOAD} supplied to the load 4 is represented by the following Expression (1).

P_{LOAD}=(P_{TOTAL}−P_{LOSS}) (1)

Here, P_{LOSS} represents the power loss from consumption by components other than the load 4, and is represented by the following Expression.

P_{LOSS}=(P_{IC}+P_{SW}+P_{PMOS}+P_{NMOS}) (2)

Here, P_{IC} represents the power consumption of the core component (22, 20, 24, and the like) of the controller 16, and P_{SW} represents the power consumption accompanying the charging and discharging of the gate capacitances of the high-side transistor and the low-side transistor of the switching circuit 14. Furthermore, P_{PMOS} represents the power loss due to the on resistance of the high-side transistor, and P_{NMOS} represents the power loss due to the on resistance of the low-side transistor. In addition, P_{LOSS} includes the power loss due to the parasitic resistances (ESR) that occur in the inductor L1 and the output capacitor C1, which will be omitted in this expression.

As shown in FIG. 2, in a case in which the on time T_{ON} is fixed, in each cycle of the PFM mode, i.e., in the on period T_{ON} and the off period T_{OFF} of each cycle, the integrated value of the coil current I_{LX} supplied to the output capacitor C1 (i.e., the extent of the increase of the output voltage V_{OUT}) corresponds to the inductance value of the inductor L1_1.

Specifically, as represented by (i) in FIG. 2, as the inductance value becomes smaller, the integrated value of the coil current I_{LX} becomes greater, and accordingly, the extent of the increase of the output voltage V_{OUT} per cycle becomes greater. Conversely, as represented by (ii) in FIG. 2, as the inductance value becomes grater, the integrated value of the coil current I_{LX} becomes smaller, and accordingly, the extent of the increase of the output voltage V_{OUT} per cycle becomes smaller.

That is to say, as represented by (i), as the inductance value becomes smaller, the switching frequency f₁ becomes lower in the PFM mode. Conversely, as represented by (ii), as the inductance value becomes greater, the switching frequency f₂ becomes higher.

As shown in FIG. 3, as the switching frequency becomes higher, i.e., as the inductance value becomes greater, the power consumption P_{IC} of the core component and the electric power P_{SW} required to charge and discharge the gate capacitances of the switching circuit 14 become greater.

In contrast, as the peak value of the coil current I_{LX} becomes greater, i.e., as the inductance becomes smaller, the power consumption due to the on resistances of the high-side transistor and the low-side transistor becomes greater.

As can be understood from FIG. 3, the inductance value that provides the minimum power loss P_{LOSS} i.e., the maximum efficiency, for the light load state φ1, is 1 nH. Thus, the inductance value of the inductor L1 of the first channel CH1 is set to 1 nH.

The inductance values L1_2 through L1_N of the other channels CH2 through CHN may preferably be determined so as to provide the maximum efficiency for the heavy load state φN in the same way as with conventional multi-phase DC/DC converters. In a case of calculating the inductance value under the same conditions as shown in FIG. 3, the optimum value of the inductance value is 0.47 nH.

The above is the configuration of the DC/DC converter 2. Next, description will be made regarding the advantages of the DC/DC converter 2.

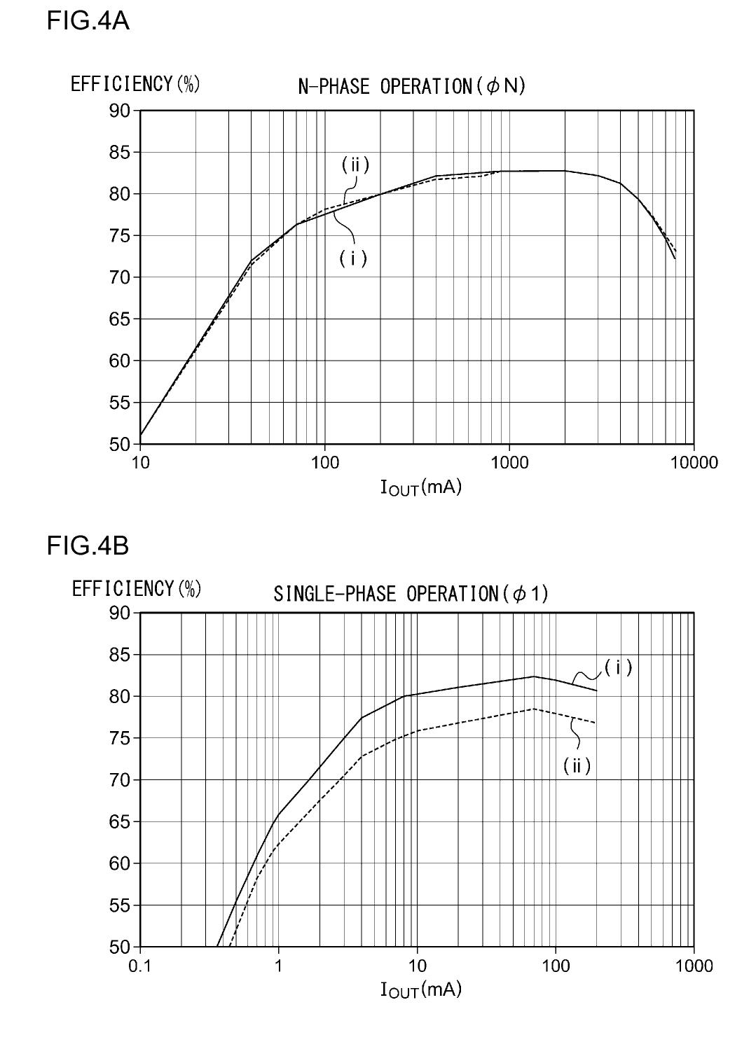

FIGS. 4A and 4B show the efficiency in the heavy load state φN and the efficiency in the lightest load state φ1, respectively. The horizontal axis represents the load current I_{OUT}. FIGS. 4A and 4B each show (i) the efficiency of the DC/DC converter 2 according to the embodiment configured with the inductance of the first channel CH1 as 1 μH and with the inductances of the other channels as 0.47 μH, and (ii) the efficiency of the DC/DC converter according to conventional techniques configured with the inductances of all the channels as 0.47 μH.

With the DC/DC converter 2 according to the embodiment, the inductance of the first channel CH1 is determined giving priority to the efficiency in the lightest load state φ1. Thus, as shown in FIG. 4B, such an arrangement provides an improvement in efficiency on the order of 5% as compared with conventional techniques.

On the other hand, as can be understood from FIG. 4A, in a range of the largest load current I_{OUT} (I_{OUT}≈8000 mA), the DC/DC converter 2 according to the embodiment has a worsening in efficiency on the order of 1.3%. This is because such an arrangement leads to an increase in the DC resistance component of the first channel CH1 due to the increased inductance L1_1 of the first channel CH1, and this leads to an increase in the power loss of the first channel CH1. However, the great improvement in efficiency in the lightest load state φ1 fully compensates for the minor worsening in efficiency in the heavy load state.

The load current I_{OUT} supplied to the load 4 fluctuates with the passage of time. The consumed power P [Wh] of the overall system including the DC/DC converter 2 and the load 4 is represented by the following Expression.

P=(T₁×P₁+T₂×P₂+ . . . T_{N}×P_{N})=(Σ_{i=1:K}Tᵢ·Pᵢ) (3)

Here, Tᵢ represents the period of time during which the i-th channel is activated, and Pi represents the consumed power in this period of time.

Depending on the kind of load 4, there are cases in which the term (T₁×P₁), which represents the consumed power in the lightest load state in which the activated channel is a single channel alone, is greater than, or otherwise is non-negligible as compared with, the power consumption in the other states. For example, if the DC/DC converter 2 is mounted on an electronic device such as a laptop PC, tablet PC, TV, recorder device, game device, or the like, in such a case, T₁ corresponds to the period of time in which the electronic device is in the standby state. With such an arrangement, in some cases, the period of time T₁ of the standby state is longer than the other periods of time T₂, T₃, . . . , T_{N}, in which the electronic device is actually used or operated. In this case, in some cases, the term (T₁×P₁) is dominant.

In such a situation, with the DC/DC converter 2 according to the embodiment, the inductance value of the inductor L1_1 is determined such that high efficiency is provided in the lightest load state φ1. This provides reduced power consumption.

From a different viewpoint, the inductor L1_1 provided for the channel CH1 which is the single channel to be activated in the lightest load state φ1 has an inductance that is higher than those of the inductors L1_2 through L1_N of the other channels CH2 through CHN.

This allows the peak value of the coil current I_{LX} to be reduced in the lightest load state φ1. With such an arrangement, a reduction in the power loss due to the on resistances of the switching elements (high-side transistor and low-side transistor) of the switching circuit 14 is greater than an increase in the power loss accompanying an increase in the switching frequency. Thus such an arrangement provides improved efficiency of the overall system.

Description has been made regarding the present invention with reference to the embodiment. The above-described embodiment has been described for exemplary purposes only, and is by no means intended to be interpreted restrictively. Rather, it can be readily conceived by those skilled in this art that various modifications may be made by making various combinations of the aforementioned components or processes, which are also encompassed in the technical scope of the present invention. Description will be made below regarding such modifications.

### First Embodiment

With the DC/DC converter 2 according to the embodiment, the inductors L1_1 through L1_N of the multiple channels are designed to have different values. Thus, in a case in which the switching circuits 14 of the respective channels are switched on and off with the same duty ratio, this leads to a risk of deviation in the coil currents I_{LX}. Furthermore, if there are irregularities in the on resistances of the power transistors that form the switching circuits 14 of the respective channels, this leads to a risk of deviation in the coil currents I_{LX}. If a large current flows through the inductor L1_i of a particular channel CHi, this leads to degradation of the inductor L1_i. Description will be made in the first modification regarding a specific configuration of a DC/DC converter 2a which is capable of suppressing such deviation in the currents.

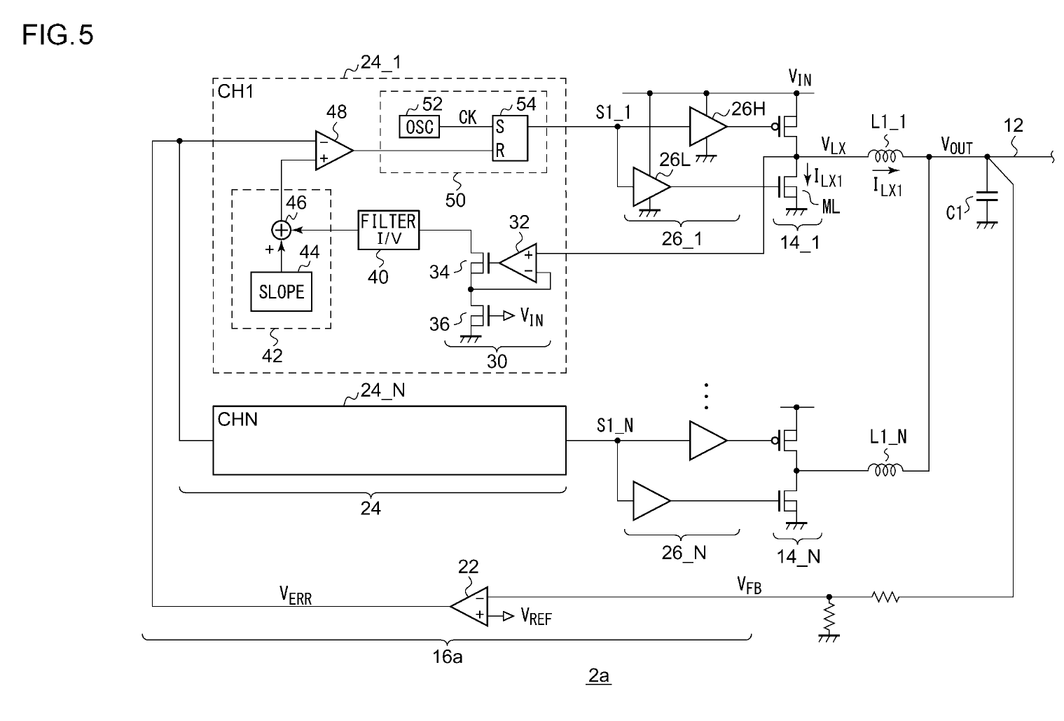

FIG. 5 is a circuit diagram showing the DC/DC converter 2a according to the first modification.

The controller 16a includes an error amplifier 22, and pulse modulators 24_1 through 24_N and drivers 26_1 through 26_N for the respective channels. The pulse modulators 24_1 through 24_N each have the same configuration. Accordingly, description will be made only regarding the first channel.

The pulse modulator 24_1 is configured as a so-called average current mode pulse width modulator. The pulse modulator 24_1 detects the current I_{LX1} that flows through the inductor L1_1 of the corresponding channel. Furthermore, the pulse modulator 24_1 generates a pulse signal S1_1 having a duty ratio adjusted such that the average current I_{LX1}_{_{—}}_{AVE} of the current I_{LX1} matches the current level that corresponds to the error voltage V_{ERR}.

The pulse modulator 24_1 includes a current detection circuit 30, a filter 40, a slope compensator 42, a PWM comparator 48, and a pulse generator 50. The current detection circuit 30 detects the coil current I_{LX1} based on the voltage drop (drain-source voltage) across the low-side transistor ML of the corresponding switching circuit 14_1 in the on state.

For example, the current detection circuit 30 includes an error amplifier 32, a first transistor 34, and a second transistor 36. The second transistor 36 is configured as an N-channel MOSFET in the same manner as the low-side transistor ML. The second transistor 36 is arranged such that its gate receives the same voltage V_{IN} as that input to the low-side transistor ML in the on state. The source of the first transistor 34 is connected to the drain of the second transistor 36. The error amplifier 32 is arranged such that its non-inverting input terminal receives the drain voltage V_{LX} of the low-side transistor ML, i.e., the drain-source voltage V_{DS} of the low-side transistor ML in the on state. The inverting input terminal of the error amplifier 32 is connected to the drain of the second transistor 36. The error amplifier 32 performs a feedback control operation such that the drain voltage of the second transistor 36 becomes equal to the drain voltage V_{LX} of the low-side transistor ML. Thus, regarding the second transistor 36 and the low-side transistor ML, their drain voltages become equal, their gate voltages become equal, and their source voltages become equal. Thus, a detection current I_{LX1}′ flows through the second transistor 36 in proportion to the coil current I_{LX1} that flows through the low-side transistor ML.

It should be noted that the configuration of the current detection circuit 30 is not restricted to such an arrangement shown in FIG. 5. Rather, other circuits may be employed according to known techniques.

The filter 40 removes the high-frequency component of the detection current I_{LX}′, and converts the detection current I_{LX}′ into a detection signal in the form of a voltage signal. The slope compensator 42 includes a slope generator 44 which generates a slope signal and an adder 46 which superimposes the slope signal on the output of the filter 40. The PWM comparator 48 compares the error voltage V_{ERR} with the output of the slope compensator 42. When the output of the slope compensator 42 becomes greater than the error voltage V_{ERR}, i.e., when the coil current I_{LX1} exceeds the current level that corresponds to the error voltage V_{ERR}, the PWM comparator 48 asserts (sets to high level) a reset signal S_{RST}.

The pulse generator 50 includes an oscillator 52 and a flip-flop 54. The oscillator 52 generates a clock signal CK having the period Ts of the pulse width modulation. The flip-flop 54 is arranged such that the clock signal CK is input to its set terminal and the reset signal S_{RST} is input to its reset terminal. The output S1_1 of the flip-flop 54 transits to high level for every period Ts in response to the positive edge of the clock signal CK. The output S1_1 of the flip-flop 54 transits to low level when the reset signal S_{RST} is asserted.

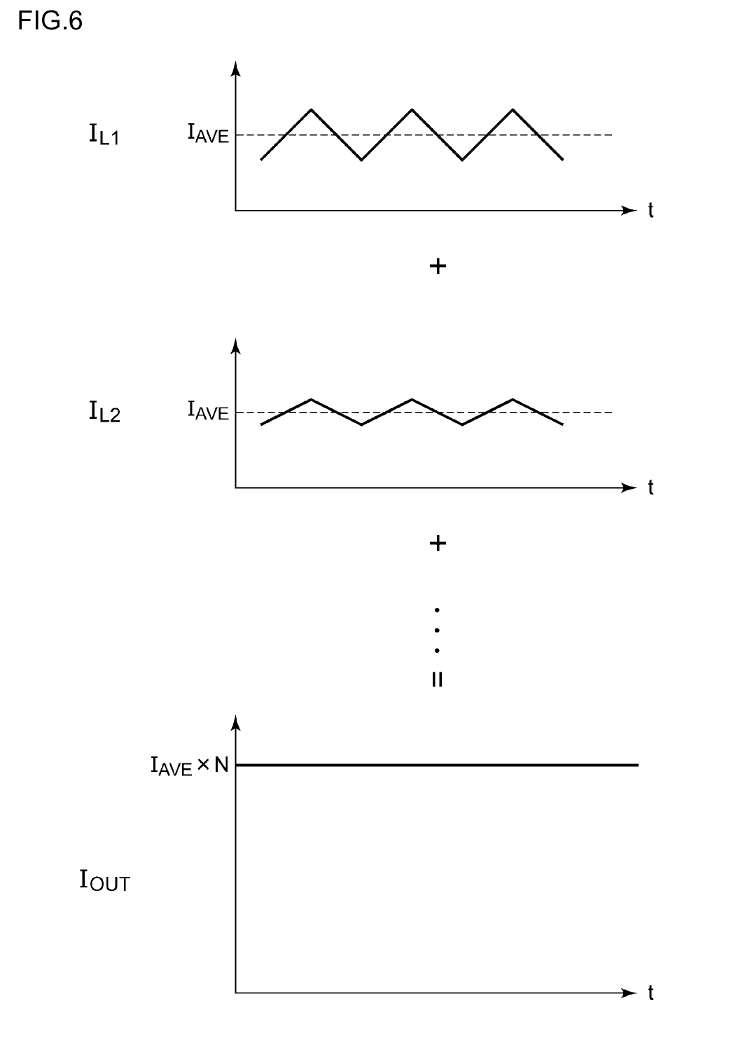

The above is the configuration of the DC/DC converter 2a. Next, description will be made regarding the operation of the DC/DC converter 2a. FIG. 6 is an operation waveform diagram showing the operation of the DC/DC converter 2a shown in FIG. 5 in the heavy load state φN. For each channel CH, the coil current I_{LX} is stabilized to the average current I_{AVE} that corresponds to the common error voltage V_{ERR}. When the N channels are activated, the average current I_{AVE} is represented by I_{OUT}/N.

As described above, with the DC/DC converter 2a according to the first modification, such an arrangement allows the currents that flow through the respective inductors of the multiple channels to have an equal value regardless of irregularities in the inductances of the multiple channels. Thus, such an arrangement is capable of suppressing deviation in the coil currents.

### Second Embodiment

Description has been made in the embodiment regarding a step-down DC/DC converter. However, the present invention is not restricted to such an arrangement. Also, the present invention is applicable to a step-up DC/DC converter and a step-up/step-down DC/DC converter.

While the preferred embodiments of the present invention have been described using specific terms, such description is for illustrative purposes only, and it is to be understood that changes and variations may be made without departing from the spirit or scope of the appended claims.

What is claimed is:

1. A multi-phase DC/DC converter comprising:
an output line connected to a load;
an output capacitor connected to the output line;
a plurality of inductors provided for respective channels, and arranged such that one end of each of the inductors is connected to the output line;
a plurality of switching circuits provided for the respective channels, and arranged such that their respective output terminals are connected to the other ends of the respective inductors; and
a controller configured to change the number of channels to be activated according to an amount of load current that flows through the load, and to control the switching circuits that correspond to the activated channels such that a feedback voltage that corresponds to an output voltage at the output line matches a predetermined target voltage,
wherein, in a lightest load state in which only a single channel is activated, the inductor provided for the single channel is designed to have an inductance value that differs from the inductances of the inductors of the other channels so as to provide high efficiency in the lightest load state.

2. The DC/DC converter according to claim 1, wherein the inductors of the aforementioned other channels are configured to have equal values.

3. The DC/DC converter according to claim 1, wherein the inductances of the inductors of the aforementioned other channels are determined so as to provide high efficiency in a heavy load state.

4. The DC/DC converter according to claim 1, wherein the controller comprises:
an error amplifier configured to amplify the difference between the feedback voltage and the target voltage so as to generate an error voltage; and
a plurality of pulse modulators provided for the respective channels, and each configured to generate a pulse signal having a duty ratio adjusted such that an average value of a coil current that flows through the inductor of the corresponding channel approaches a current value that corresponds to the error voltage.

5. The DC/DC converter according to claim 4, wherein the plurality of pulse modulators each comprise:
a current detection circuit configured to detect the corresponding coil current, and to generate a detection signal that corresponds to the coil current;
a filter configured to remove a high-frequency component of the detection signal;
a slope compensator configured to superimpose a slope signal on the detection signal;
a comparator configured to compare the output of the slope compensator with the error voltage, and to generate a reset signal; and
a pulse generator configured to generate a pulse signal having a level that transits according to the reset signal and a clock signal having a predetermined period.

6. A multi-phase DC/DC converter comprising:
an output line connected to a load;
an output capacitor connected to the output line;
a plurality of inductors provided for respective channels, and arranged such that one end of each of the inductors is connected to the output line;
a plurality of switching circuits provided for the respective channels, and arranged such that their respective output terminals are connected to the other ends of the respective inductors; and
a controller configured to change the number of channels to be activated according to an amount of load current that flows through the load, and to control the switching circuits that correspond to the activated channels such that a feedback voltage that corresponds to an output voltage at the output line matches a predetermined target voltage,
wherein, in a lightest load state in which only a single channel is activated, the inductor provided for the single channel is designed to have an inductance value that is higher than the inductances of the inductors of the other channels.

7. The DC/DC converter according to claim 6, wherein the inductors of the aforementioned other channels are configured to have equal values.

8. The DC/DC converter according to claim 6, wherein the inductances of the inductors of the aforementioned other channels are determined so as to provide high efficiency in a heavy load state.

9. The DC/DC converter according to claim 6, wherein the controller comprises:
an error amplifier configured to amplify the difference between the feedback voltage and the target voltage so as to generate an error voltage; and
a plurality of pulse modulators provided for the respective channels, and each configured to generate a pulse signal having a duty ratio adjusted such that an average value of a coil current that flows through the inductor of the corresponding channel approaches a current value that corresponds to the error voltage.

10. The DC/DC converter according to claim 9, wherein the plurality of pulse modulators each comprise:
a current detection circuit configured to detect the corresponding coil current, and to generate a detection signal that corresponds to the coil current;
a filter configured to remove a high-frequency component of the detection signal;
a slope compensator configured to superimpose a slope signal on the detection signal;
a comparator configured to compare the output of the slope compensator with the error voltage, and to generate a reset signal; and
a pulse generator configured to generate a pulse signal having a level that transits according to the reset signal and a clock signal having a predetermined period.

11. An electronic device comprising:
a processor; and
the DC/DC converter according to claim 1, configured to supply a power supply voltage to the processor.

12. An electronic device comprising:
a processor; and
the DC/DC converter according to claim 6, configured to supply a power supply voltage to the processor.
